(19) United States
(12) Patent Application Publication
(10) Pub. No.: US 2014/0350907 A1
(43) Pub. Date: Nov. 27, 2014

(54) METHOD AND DEVICE FOR SOLID DESIGN OF A SYSTEM

(71) Applicant: COMMISSARIAT A L'ENERGIE ATOMIQUE ET AUX ENERGIES ALTERNATIVES, Paris (FR)

(72) Inventors: Armand Nachef, Montigny-le-Bretonneux (FR); Francois Terrier, Orsay (FR)

(21) Appl. No.: 14/365,564

(22) PCT Filed: Dec. 13, 2012
(86) PCT No.: PCT/EP2012/075459

§ 371 Date: Jun. 13, 2014

(30) Foreign Application Priority Data
Dec. 15, 2011 (FR) 1161653

(51) Int. Cl. G06F 17/50; G06F 9/44

(52) U.S. Cl. CPC G06F 17/50; G06F 8/35
USPC 703/6

(57) ABSTRACT

A method for solid design of a system comprises notably a step of construction of a solid model on the basis of solid bricks representing sub-systems of the system, of solid ties representing relationships between the sub-systems. The method furthermore comprises a step of dematerialization of the solid model into a model suitable for being interpreted by a computer. The method applies notably in the sector of the production of industrial systems that are complex due to their significant number of components, the various links between the numerous components.

The present invention relates to a method and a device for solid design of a system. The present invention applies notably in the sector of the production of industrial systems that are complex due to their significant number of components, the various links between the numerous components.

In the field of designing systems comprising notably multiple sub-systems, it is commonplace to use design software, such as computer-aided design software. Computer-aided design tools may use a graphical modeling language based on pictograms defined by a standard, for example the SysML standard, the acronym standing for the expression Systems Modeling Language. The SysML language is a variant of the UML language, the acronym standing for the expression Unified Modeling Language. SysML was created to be a universal and visual design language. The power and the benefit of SysML stem notably from the fact that SysML normalizes a semantics to describe modeling concepts that it uses. SysML is above all a communication support facilitating the representation and the understanding of systems.

The growing complexity of systems implies that it is becoming increasingly difficult to represent a system on a screen or on a set of screens. Notably, current computer screens have a very limited size in comparison with the complexity of the system models. To remedy this problem, a zoom function can be used in the design software. For example an object of the system can be represented by a name and it is necessary to magnify it by virtue of a zoom function, in order to view the properties and function of the object. In the same manner, it is necessary to magnify each function in order to understand its behavior. Moreover, systems modeling calls upon various viewpoints to model different facets of a system, such as its structure, the interactions between its components and the processing operations that it carries out. Each aspect can be modeled with the aid of a specific diagram, the various diagrams mutually complementing one another. It has therefore become impossible to have a sufficiently detailed overall view of a system. Thus, systems are increasingly evading their designer and sometimes ultimately have a behavior that does not correspond to what the designer had desired, or indeed that does not fulfill the functional requirements to which it is subjected. These design defects can thereafter be detected only late in the system test phases. A design defect detected once the system has been produced may be crippling for the system itself, said design defect often being impossible or very expensive to correct at this juncture in the production.

Furthermore, the architectural description is often represented by several views corresponding to different concerns (such as concerns over security, safety, performance, reliability, availability, maintenance capability, cost, fabrication timescale, profitability, etc.). Each view is represented by tens of models representing several abstractions of the system, of several levels. Each model in its turn is represented by tens of elements connected together with links of various kinds. Each element or link also possesses tens of properties taking values having varied types. Furthermore, elements belonging to different models or views may likewise have overall correspondences.

On account of this complexity, the exhaustive description of an architecture is represented in a database which quickly becomes very voluminous and difficult for a human to understand. SysML diagrams are partial representations of this architectural description. These diagrams are used to aid users to understand, on the basis of extracts, the global architecture of the system, and to supplement the inputting of the data of the system by means of diagrams. However, the existing SysML diagrams, in their form and with the current tools, may turn out to be ineffective. Indeed, screens have limited dimensions which do not make it possible to represent the diagrams and their interactions in an exhaustive and exploitable manner. Moreover, the construction of the SysML diagrams with available input peripherals (keyboard, mouse) remains very tiresome work.

An aim of the invention is notably to alleviate the aforementioned drawbacks. For this purpose, the subject of the invention is a method of designing a system comprising as a preliminary the construction of a solid model of the system, the solid model being constructed according to a solid meta-model, said solid model using solid bricks representing sub-systems of the system, solid ties representing relationships between the sub-systems of the system, the solid bricks and the solid ties being physical objects associated with a respective identifier. The method comprises, in response to a modification of the solid model, a step of converting the solid model into a design model suitable for being interpreted by a computer, on the basis of the identifiers associated with each brick and with each solid tie, said conversion step comprising the conversion of the solid model into a set of data representative of the solid model and maintained in a data structure relating to the solid model. The first data structure is advantageously associated with a second data structure relating to the design model.

The method can furthermore comprise the conversion of the design model into assembly instructions for modifying the solid model in response to a modification of the design model.

The design model can be a SysML model.

The solid model can comprise static diagrams and dynamic diagrams, the static diagrams defining the ties between the solid bricks, the dynamic diagrams defining successions of processing operations, of exchanges of messages between the sub-systems of the system.

In particular, the solid meta-model can define a grammar for the solid model, a context of use of the system, a mode of representation of the solid bricks and ties according to their type.

Each solid brick and each solid tie can comprise an identification label associated with its identifier.

In one embodiment of the invention, the identifiers of the solid bricks and ties can be read by means of a digital device for reading and recognition of the solid model.

The solid model once read can be transcribed into a file comprising data necessary for the description of the solid model and for the interpretation of the data for describing the solid model by a computer.

According to a characteristic of the invention, the data structure associated with the solid model stores the physical characteristics of each solid brick of the solid model.

The method can comprise a step of converting the data maintained in the data structure relating to the solid model into assembly instructions for constructing the corresponding solid model.

The step of converting the data maintained in the data structure relating to the solid model into assembly instructions can comprise a step of transcribing the data maintained in the data structure relating to the solid model into a description file comprising data of the description of the solid model.

As a supplement, the method can comprise a step of identifying differences between the solid model and the data maintained in the data structure.

The solid meta-model can comprise representation concepts present in the SysML standard, the acronym standing for the expression Systems Modeling Language.

The solid meta-model can comprise representation concepts present in the UML standard, the acronym standing for the expression Unified Modeling Language.

In particular, the method can comprise a step of generating software code used by a software sub-system of the system.

The invention furthermore proposes a device for design of a system comprising:
a computerized device,
a construction zone for the construction of a solid model according to a solid meta-model, the solid model using solid bricks representing sub-systems of the system, solid ties representing relationships between the sub-systems of the system, the solid bricks and the solid ties being physical objects associated with a respective identifier, and
at least one device for reading the solid model, the device being able, in response to a modification of the solid model, to convert the solid model into a design model suitable for being interpreted by the computerized device, on the basis of the identifiers associated with each brick and with each solid tie that are read by the reading devices, said conversion comprising the conversion of the solid model into a set of data representative of the solid model and maintained in a first data structure relating to the solid model. The first data structure is advantageously associated with a second data structure relating to the design model.

The identifiers can be inscribed on respective labels with the aid of digital styluses each comprising a system for reading hand-written data, the devices for reading the solid model consisting of the hand-written data reader systems of the digital styluses.

The identifiers can be carried by labels of RFID tag type, the acronym standing for the expression Radio Frequency Identification, the devices for reading the solid model being RFID reader devices.

The devices for reading the solid model can comprise at least three RFID readers which determine, according to a triangulation method, a disposition of the solid bricks and ties in a space of representation of the solid model.

As a variant, the identifiers can be carried by labels of barcode type, and the reading devices furthermore comprise barcode reader devices.

The devices for reading the solid model are designed to convert the read data into data suitable for being transmitted to a computer and for being interpreted by a computer.

The device can comprise a robot able to construct the solid model according to instructions generated by the computer comprising the description of the solid model.

The invention has notably the main advantages of allowing simple design of complex systems.

Other characteristics and advantages of the invention will become apparent with the aid of the description which follows, given by way of nonlimiting illustration, and offered with regard to the appended drawings which represent:

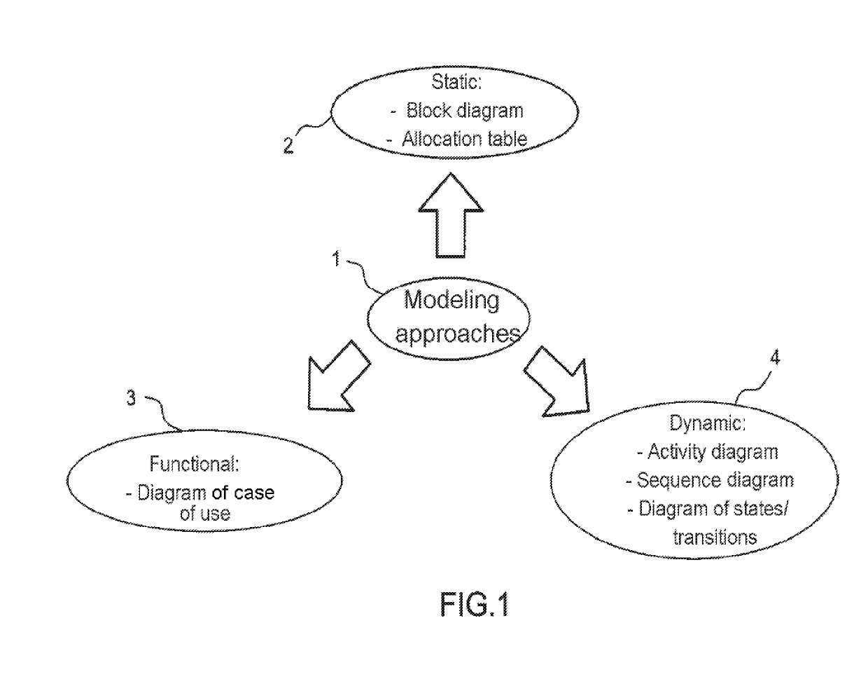

FIG. 1: an exemplary modeling of a system according to the prior art;

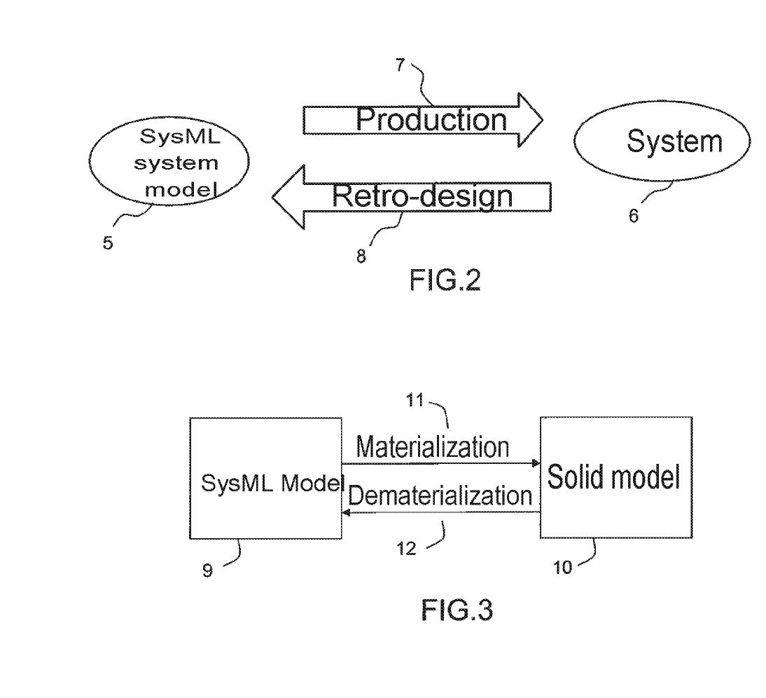

FIG. 2: a design process for a system according to the prior art;

FIG. 3: a basic schematic of the method according to the invention;

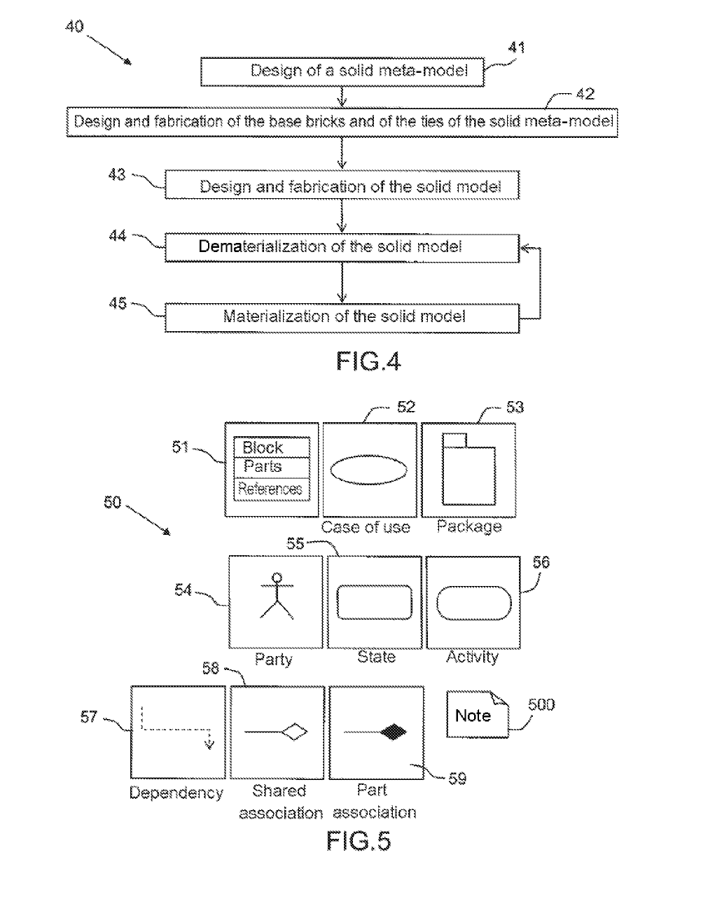

FIG. 4: a schematic of various steps of the method according to the invention;

FIG. 5: an example of base elements of SysML modeling according to the prior art;

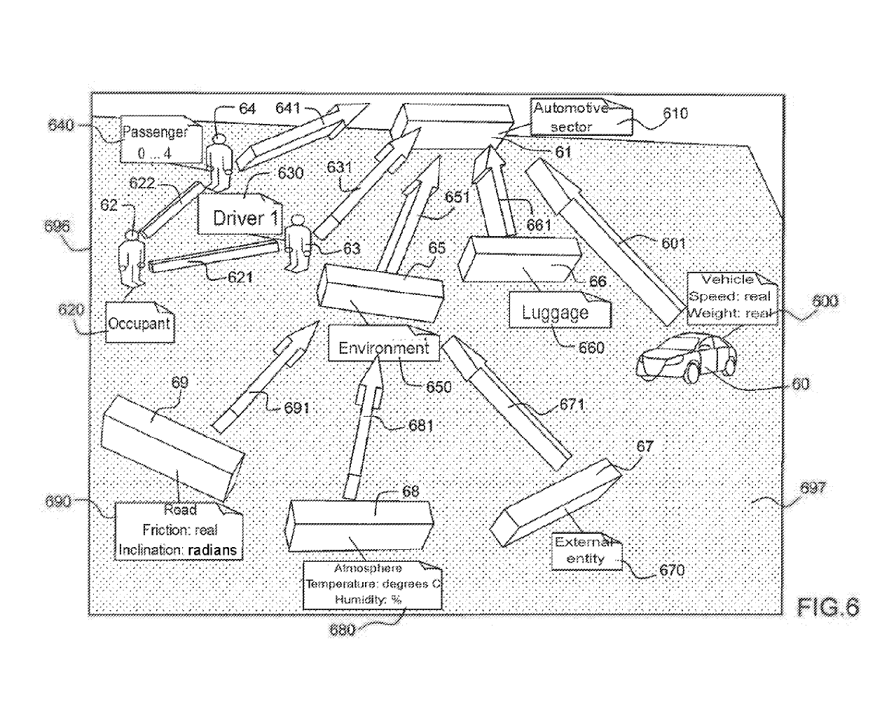

FIG. 6: a diagram of a conventional SysML model of a system, produced with solid bricks according to the invention;

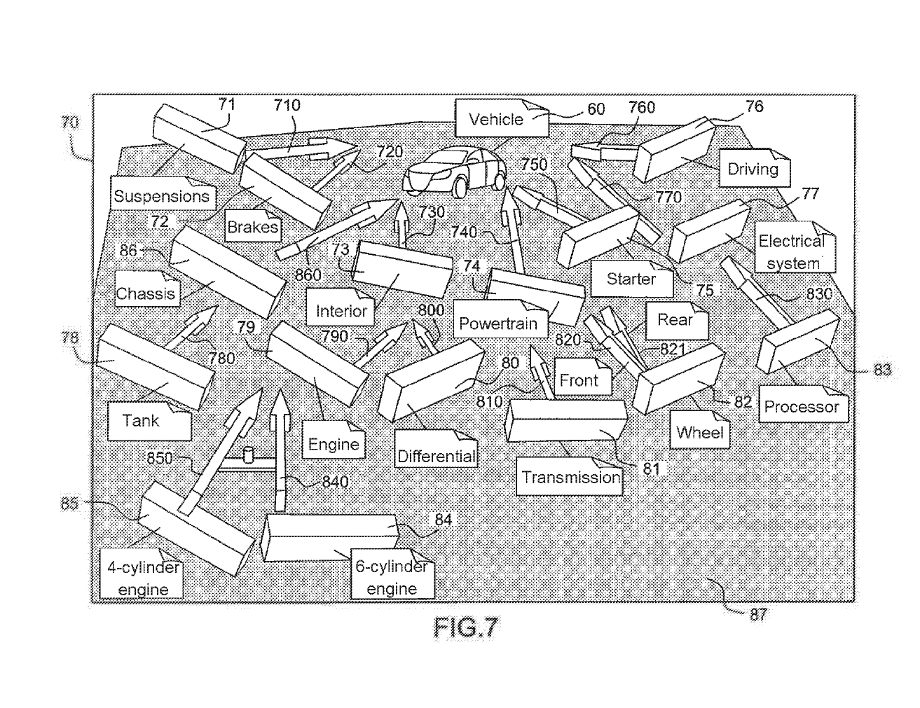

FIG. 7: a conventional SysML example of decomposing the system into sub-systems according to the prior art, produced with solid bricks according to the invention;

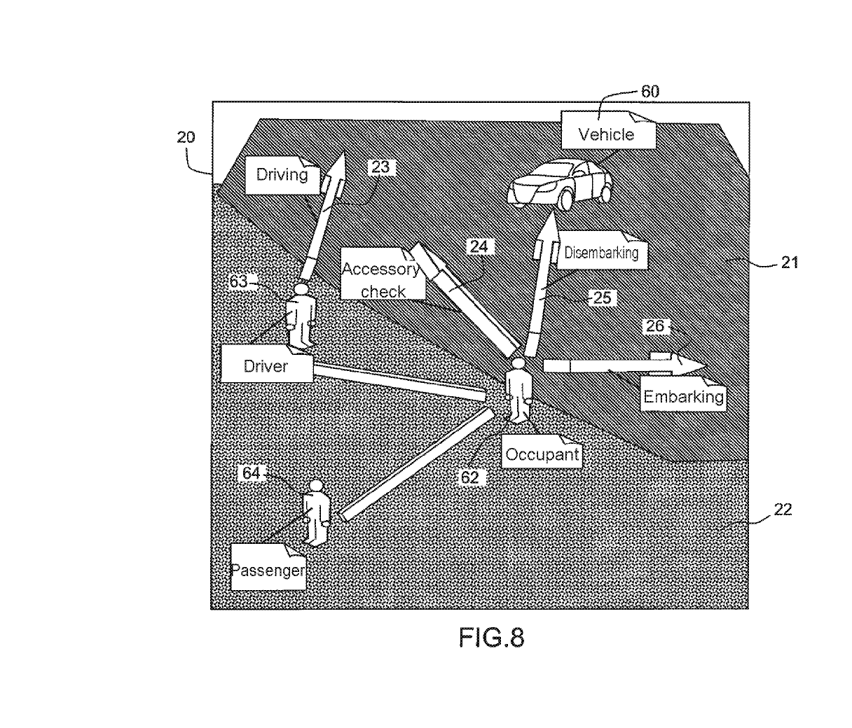

FIG. 8: a conventional example of a SysML case model of use of the system, produced with solid bricks according to the invention;

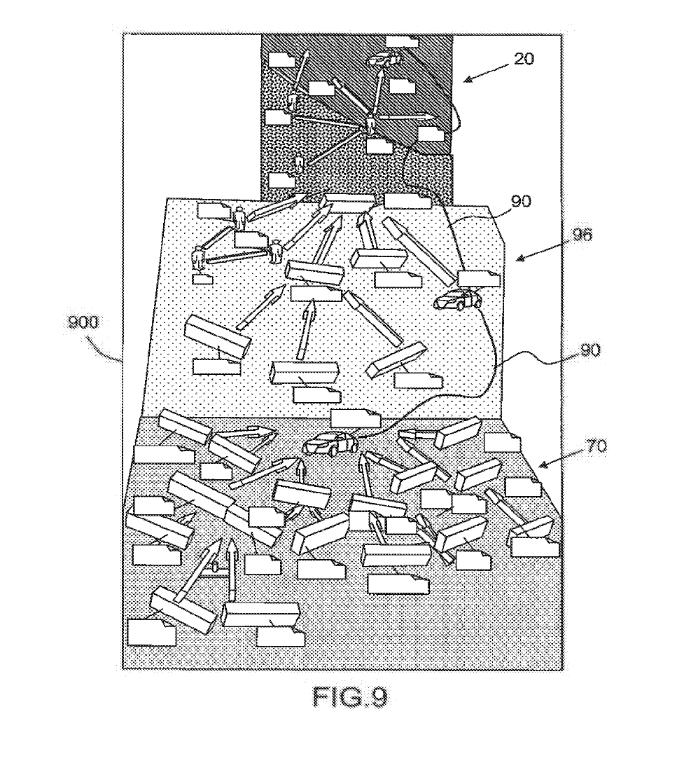

FIG. 9: an example of links with strings between various of the system's design diagrams produced with solid bricks according to the invention;

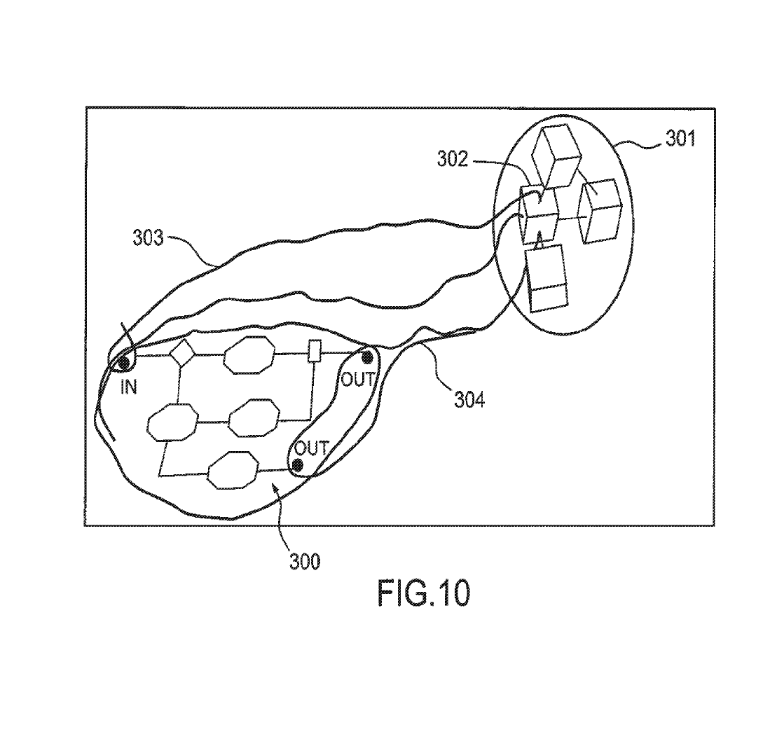

FIG. 10: an exemplary activity diagram of a sub-system of the system according to the invention;

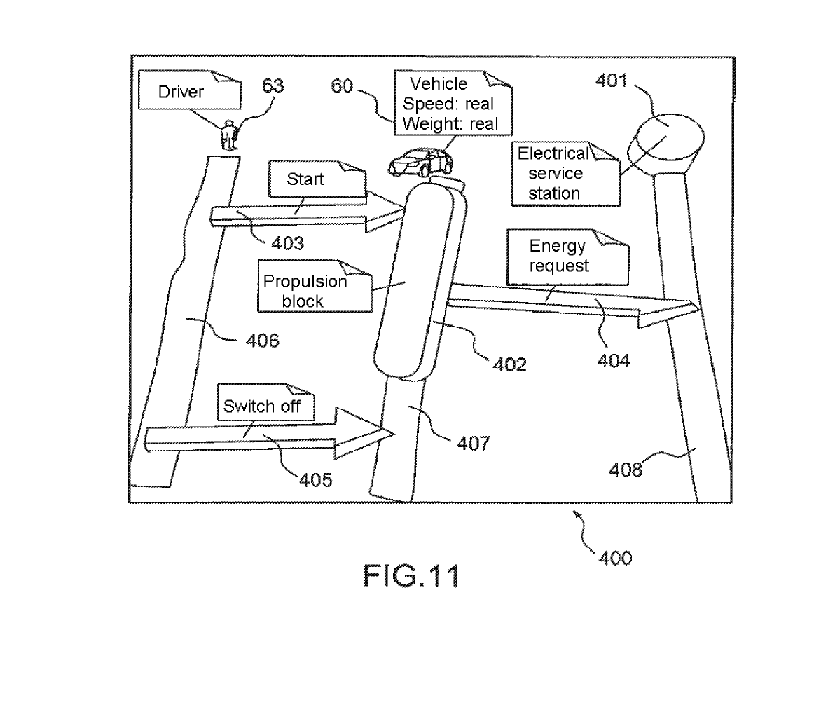

FIG. 11: a first example of an asynchronous sequence diagram of a case of use of the system according to the invention;

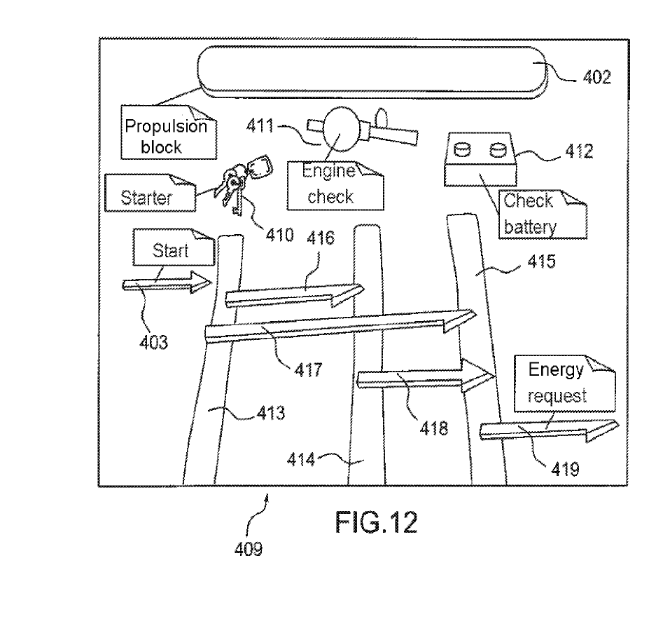

FIG. 12: a second example of a synchronous sequence diagram of a case of use of the system according to the invention;

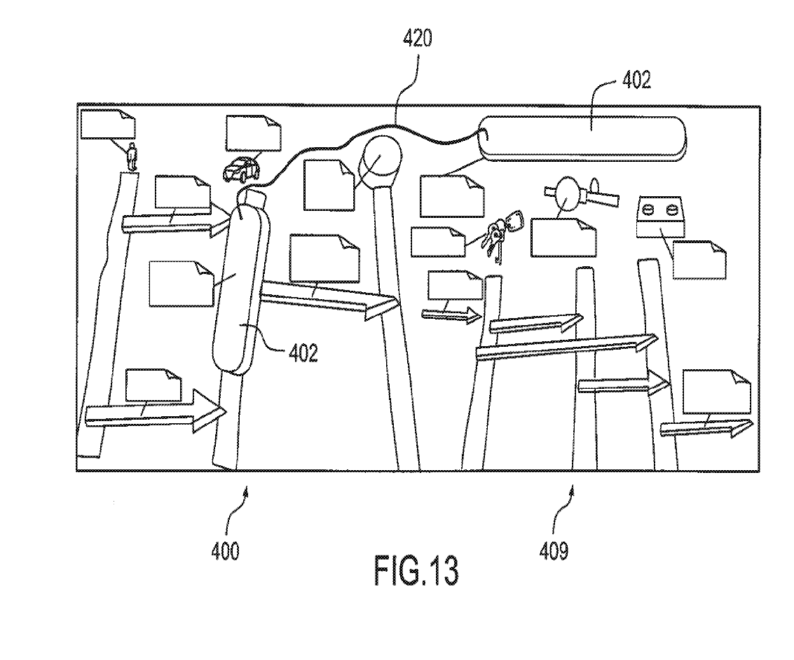

FIG. 13: an exemplary relationship between the first exemplary sequence diagram and the second exemplary sequence diagram, according to the invention;

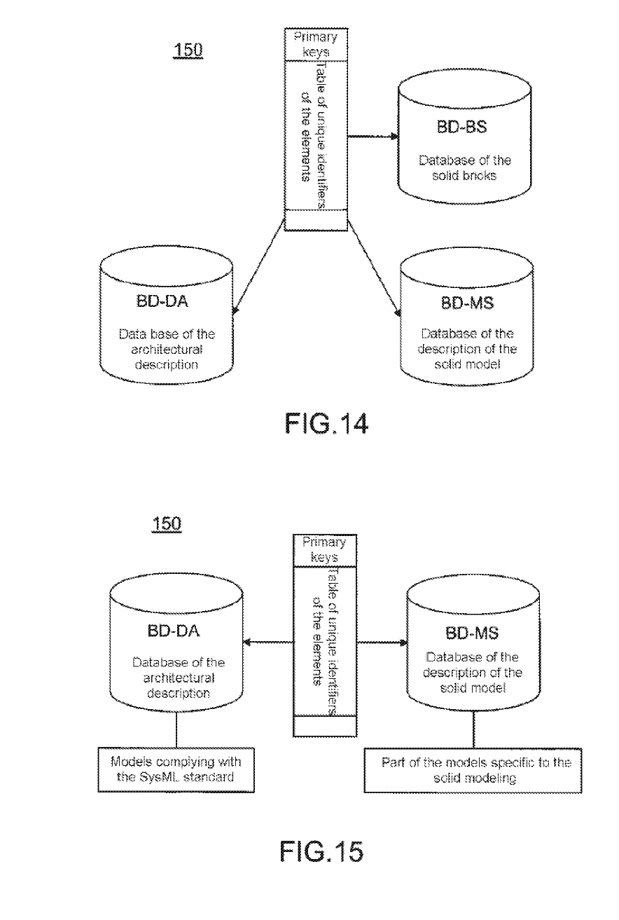

FIG. 14 represents the data structures maintained in the computerized device, according to an embodiment of the invention;

FIG. 15 illustrates the interactions between two of the data structures of FIG. 14;

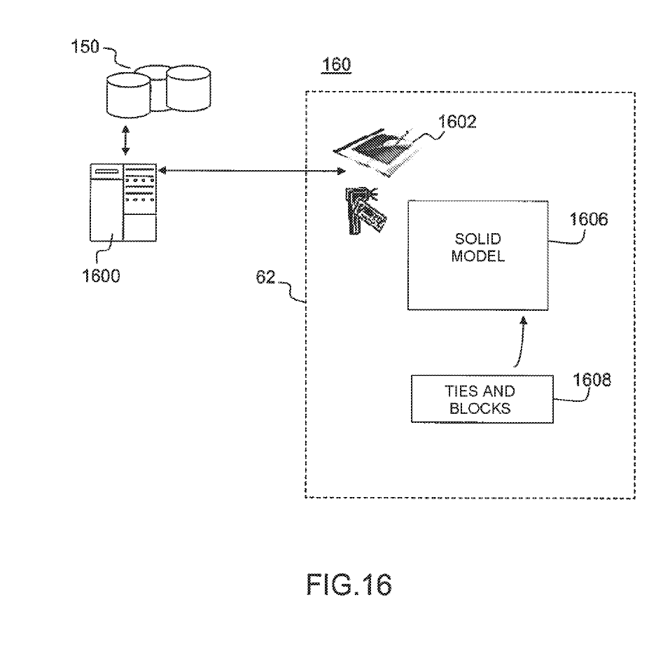

FIG. 16 is a functional schematic representing the design system according to an embodiment of the invention;

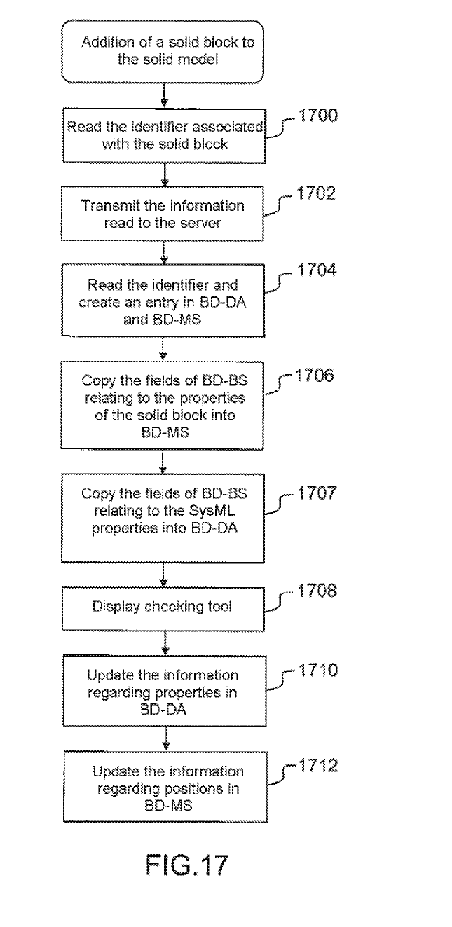

FIG. 17 is a flowchart representing the various steps implemented in response to the addition of a solid block to the solid model according to an embodiment of the invention; and

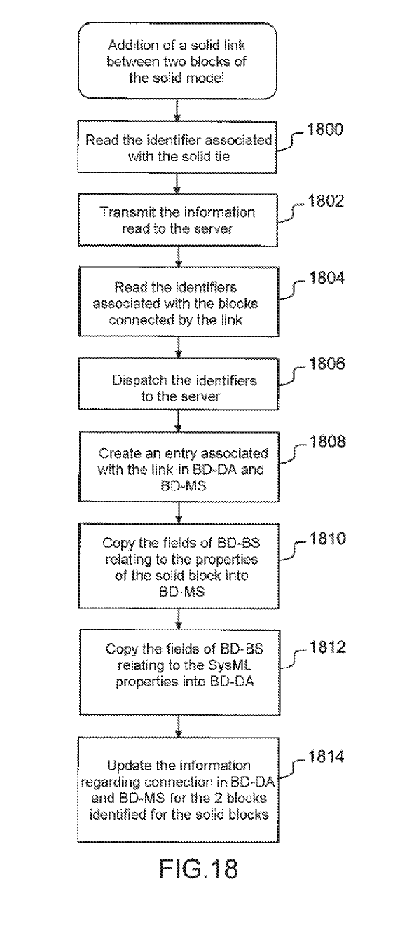

FIG. 18 is a flowchart representing the various steps implemented in response to the addition of a solid link to the solid model according to an embodiment of the invention.

FIG. 1 represents an exemplary modeling of a system according to the prior art. The system in question may be a car, an airplane, or any other system comprising numerous sub-systems. The modeling of a system uses notably design tools, in the form of computer-aided design software, which use some or all of the notations and semantics described by the SysML language. The design software can offer various modeling approaches 1 such as:
a static modeling approach 2, using notably block diagrams for a static representation of the system;
a functional modeling approach 3, using for example diagrams of representations of various cases of use;
a dynamic modeling approach 4, using notably activity diagrams, sequence diagrams, diagrams of states/transitions to represent ways in which the system operates.

The design tools therefore allow creation and modification of diagrams in accordance with the graphical notation of SysML for example. The design tools therefore represent the system as a superposition of multiple diagrams, each diagram being representative of a modeling approach 1. For systems comprising numerous sub-systems, the design tools do not provide a both clear and precise global view of the system.

FIG. 2 schematically represents a design process for a system according to the prior art. The system design processes use notably a “to-and-fro” process such as represented in FIG. 2. The process begins from a first model of the system 5 for example using the SysML language to produce a system 6. Thereafter a retro-design can be produced to update the first model of the system 5 on the basis of the system 6. Each design of a system is an iterative process of enhancement, revision, and modification of architectural details of the system 6. The “to-and-fro” process allows a designer to edit the system model 5 at any time, while taking account of modifications made by a producer of the system 6. This makes it possible to shorten the timescale between the design and the production of the system 6. The absence of a sufficiently detailed global view of the system as well as the difficulty in establishing a correspondence between the diagrams of the model of the system 5 imply that the “to-and-fro” design/production process is very complex to implement or indeed not supported by existing design tools.

The “to-and-fro” schematic can be applied to a design whose object is not the production of the system 6 but the specification of the system 6. In this case, production 7 is replaced with generation of specification documents for example: a blueprint, a detailed design folder. The retro-design 8, in this case, can take the specification documents as input and yield a model 5 of the system.

The “to-and-fro” schematic represented in FIG. 2 can also be applied to a software system. The model of the system 5 in this case is a UML model, the acronym standing for the expression Unified Modeling Language. Production may be for example automatic generation of code of a piece of software of the system 6.

FIG. 3 represents a basic schematic of the method of designing a system according to the invention. The method according to the invention may for example take a model of the system 9 as input. The model of the system may be written in the SysML language, or any other modeling language.

The design method according to the invention comprises a step of so-called “materialization” 11, making it possible to construct a “solid” model representing the system 6. The materialization step is a step of creating a real physical representation, in two or three dimensions, of the SysML model. For example the materialization step can be a step of constructing a “solid” model composed of solid bricks linked to one another by solid ties so as to portray various diagrams of the SysML model. The solid ties are represented in a concrete manner, thus making it possible to identify them and to identify their type. The solid bricks have a precise definition thus ascribing them a clear semantics. Each solid brick can be identified by a “label” so as to guarantee its uniqueness in the solid model 10. The label can be a name or a single alphanumeric identifier for each solid model 10. The materialization step 11 can be carried out manually, or automatically by a robot in accordance with assembly instructions produced on the basis of the SysML model 9. The assembly instructions can be produced by a first suitable piece of software, said first piece of software being capable of verifying the equivalence of the SysML model 9 and solid model 10.

The design method according to the invention can also comprise a retro-design step named dematerialization step 12. The dematerialization step 12 begins from a “solid” model 10 previously constructed either manually, or automatically, by a robot for example. The aim of the dematerialization step is to convert the physical solid model into a set of data representative of the solid model and maintained in a suitable data structure in the computerized device. This data structure relating to the physical model is associated with a data structure relating to the corresponding SysML model. The dematerialization step comprises a step of reading the “solid” model with a suitable reader, connected to a computer, so as to translate the “solid” model into a SysML model for example. A second suitable software program reads the solid model 10, analyzes it and then transposes it automatically into a SysML model 9, for example, by using the respective data structures associated with the physical model and with the SysML model. The second software program identifies the bricks by virtue of the reading of their label and determines the links which connect them as a function of the type of solid tie used.

FIG. 4 represents various possible steps for the design method 40 according to the invention.

A step preliminary to the use of the design method according to the invention can be a solid meta-model design step. The solid meta-model makes it possible to define a grammar as well as a context of use of the meta-model. The context of use of the solid meta-model may be that of the sector for which the modeling 1 is carried out. The sector may be the automotive sector, the avionics sector, for example.

For a modeling using a SysML model, the solid meta-model may for example comprise SysML representation concepts. Each element of a SysML modeling has a solid representation in the solid meta-model. In the same manner, each SysML diagram can have a representation according to the solid meta-model. In another exemplary implementation of the method according to the invention, the solid meta-model can comprise UML modeling concepts. The solid meta-model can also define other information, in addition to the modeling concepts, such as information regarding geometric representation in three dimensions.

Another step preliminary to the use of the method according to the invention can be a step of design and fabrication of base bricks, of connection bricks between the base bricks. The base bricks can be augmented with connection point, or with nodes. The base bricks and the connection bricks are constructed according to the solid meta-model. Each element of the solid meta-model can therefore have a solid representation corresponding to a solid modeling element.

The base bricks, the connection bricks can be constructed in two dimensions according to a credit card format for example, or in three dimensions. Examples of base bricks are represented in FIG. 5.

A first step of the design method according to the invention can be a step of design and fabrication 43 of the solid model 10 of the system 6. The solid model 10 can notably be composed of solid diagrams. The solid model 10 comprises connections between the various solid diagrams, connections between the bricks contained in distinct solid diagrams, connections between bricks contained in each solid diagram. The solid model 10 can comprise static block diagrams, defining the blocks making up the system 6 and describing the relationships between the blocks of the system 6. The solid model 10 can also comprise dynamic diagrams, describing behaviors of the system 6 such as: state diagrams, sequence diagrams, communication diagrams, activity diagrams.

Each element of the solid model 10 can be identified and its characteristics defined by using for example labels associated with each of the objects of the system 6, inter-object ties, diagrams, inter-diagram ties, of the solid model 10. A labeling of the objects and diagrams can be carried out in several different ways: for example the labels can be printed and then associated with each object or diagram. The labels can also be hand-written. Another way of producing labels is to use electronic displays on solid bricks supplied with current. Identification labels can also be produced in code form: a series of letters, a barcode in one or two dimensions, a chip, an RFID tag, the acronym standing for the expression Radio Frequency Identification. For example, an RFID tag can be associated with each block or object of the solid model 10. A tie between two objects of the solid model 10 can also be identified by an RFID tag and by the two RFID tags of the objects that it links. A tie can therefore be identified by a passive RFID tag with a potential for storing data, so as to store the RFID tags of the solid objects situated at the ends of the tie. For example the storage of the RFID tags of the objects can be done by using a device for reading an RFID tag which writes the RFID tag read in the memory of the RFID tag of the tie, for example. The reading can be triggered by a contact between the reading device and the RFID tag.

When the labels comprise names, codes, they can be read, for example, by a digital converter reader device, such as a digital stylus. The digital stylus can be equipped for example with a miniaturized camera integrated into the tip of the digital stylus. The digital stylus can also comprise an internal memory able to store the data acquired by the camera. The digital stylus can also comprise a data exchange interface for transmitting to another device, for example a computer, the data acquired and stored by the digital stylus. The data exchange interface can notably use a Bluetooth technology, Bluetooth being a trademark of the company Bluetooth SIG Inc, a USB interface, the acronym standing for the expression Universal Serial Bus, or any other means allowing an exchange of data between two electronic devices. An advantage of using a digital stylus is that this type of stylus makes it possible notably to convert hand-written notes into alphanumeric data. Thus the user can write in his habitual manner, the mini camera integrated into the tip of the stylus automatically scans the hand-written document and the data are immediately stored in a memory integrated into the stylus, for example in the shaft of the stylus. The data saved in the stylus can thereafter be transmitted through a data link such as cited hereinabove to a computer. The gathered hand-written information is thereafter converted into structured digital data by a writing recognition engine for example. Such data can thereafter be translated according to a meta-model suitable for the representation of the solid model by the computer. For example the data can be translated according to a SysML meta-model.

The dynamic diagrams can be represented in an animated manner by using notably bricks supplied by an electrical current and comprising for example LEDs, the acronym standing for the expression Light-Emitting Diode. For example, for a sequence diagram, a message dispatch may be represented by the ignition of LED lights of several solid objects taking part in the construction and in the dispatching of the message. Such a representation advantageously facilitates a global understanding of the system 6. Such a representation thus makes it possible to correct design errors and improve the performance of the system 6. Examples of solid diagrams are represented in FIGS. 6 to 13. Advantageously an animated dynamic representation can make it possible to pinpoint possible malfunctions of the system well before its production.

A second step of the design method according to the invention can be a first step of dematerialization 44 of the solid model 10. The first step of dematerialization 44 of the solid model 10 is a step of recognizing the solid model 10 by computer. The solid model 10 can be read automatically so as to reproduce on a computer the various elements of the solid model 10, for example according to the SysML format. The labels associated with the objects and with the diagrams can be recognized and interpreted by a text recognition program for example. The solid model 10 can also be read by software for optical recognition on the basis of photos of the solid model 10 for example. The solid model 10 can also be dematerialized by a method of reading barcodes of its constituent elements, and then of associating the codes read with photos of the solid model 10. In another embodiment, the RFID tags used in the solid model can be read and located in space notably by virtue of three RFID readers whose measurements can be triangulated. The dematerialization schemes cited hereinabove can be used alone or in combination with one another.

Once read by a suitable device, the solid model 10 can be “laid flat” in a first description file for the solid model 10 using for example the XML standard, the acronym standing for the expression extensible markup language. An objective is notably to be able to represent at one and the same time the logical and physical structure of the solid model 10 in a file exploitable by a computer. If the solid model 10 is compatible with the SysML language, the first description file for the solid model 10 can be described for example according to an XMI information exchange standard, the acronym standing for the expression XML Metadata Interchange. The XMI standard defines an XML-based SysML metadata exchange standard. Advantageously, the first description and exchange file can make it possible to store information describing the solid model 10, for example information regarding position in space of the objects of the solid model 10. Indeed, certain types of information are necessary for a possible reconstruction of the solid model 10 but will not be able to be exported into a SysML model.

A third step of the design method according to the invention can be a step of converting the solid model 10 described in a second description file into a solid model which is dematerialized on a computer. The dematerialized solid model can for example be converted into a SysML model for example, or else a UML model when the system 6 comprises notably software programs. The work of converting the XML data into SysML or UML data is done by a simple deduction, the second description file borrowing all of the SysML or UML model description concepts.

When the system 6 comprises software elements, a step following the conversion step can be a step of generating code for the software of the system 6. In the same manner, on the basis of the dematerialized solid model, it is possible to automatically generate specification documents, design documents, for example.

A generating of code can also be envisaged on the basis of the solid model 10 directly by using the appropriate software tools. Thus it is possible to have a dematerialized view of the solid model 10 and a view of the software code simultaneously. Thus a looped design requiring toings and froings between the solid model 10 and the generated code can be produced.

The design method according to the invention can comprise a step of materialization 45 of a design model as a new solid model. The design model can be a SysML, UML model, or else the previously dematerialized solid model 10. A first step of the materialization as solid model can be a step of converting the design model into a third XML description file, XMI for example. The third description file for the solid model comprises descriptions of objects required for the construction of the solid model. The design model does not necessarily contain the whole set of data required for the construction of the solid model. For example, the data regarding geometric description and positioning of the objects.

A second step of the materialization 45 of the solid model can be a step of generating instructions for constructing the solid model. The construction instructions can be generated in the form of directions for constructing the solid model. The construction instructions can either be carried out manually, or automatically by a robot for example. The objects positioning description data can be generated by customary algorithms for automatic placement of objects in a space, such as anti-overlap algorithms for example commonly used by graphical interfaces. The geometric descriptions of the objects can be deduced from the solid meta-model which defines a representation for each type of object. For example the directions can comprise the following instructions: begin by placing all the solid elements corresponding to blocks in a block diagram. The objects can thereafter be linked to one another. Another way of constructing the solid model is to connect the solid blocks to one another as and when they are placed in the various diagrams of the solid model. The construction instructions can be provided to a robot to build the solid model.

The method according to the invention can also provide on request or continuously a differential between the real solid model and the dematerialized solid model by identifying for example the differences between the second description file arising from the materialization 45 of the solid model and the first description file arising from the dematerialization 44. To this end, the solid model can be scanned at any time in its construction to represent it according to a fourth XML description file for example. Thereafter the fourth description file can be compared with a reference description file of the solid model, said reference file being able to represent the last saved state of the solid model. A criterion for evaluating the differences between the fourth file and the reference file can be as follows: two description files are equivalent if and only if they can culminate in one and the same SysML, UML model for example. A solid block displacement with no change of its connections for example is not considered to be a change of the solid model. When the fourth file is different from the reference file, new construction instructions can be generated for example so as to correct the solid model. Advantageously, the ability to maintain up to date a differential between a solid model and the dematerialized solid model can be used for the purposes of collaborative work on one and the same model of teams of designers situated in distinct geographical zones for example.

FIG. 5 represents an example of base bricks 50 of the device according to the invention, overlaid onto a SysML model. For example, in FIG. 5, a first block 51 can be represented by a first card on which the word Block appears. The first block 51 can also be represented by a parallelepiped. The first block 51 can comprise several cartridges for example, each cartridge being able to define a part or a reference of the first block 51. A cartridge in the present description can be represented in the form of a box of a table, of a stage of a parallelepiped. The various cartridges can for example have a distinct color according to the type of information that they represent.

A second brick 52 can represent a case of use. A case of use is a description of a possible use of the system 6. A case of use can also be represented by a particularized surface on which bricks for describing the case of use are placed.

A third brick 53 can represent a package. A package is a set of blocks grouped together according to a property criterion for each block. A package can also be represented by a box in which the blocks making up the package are bundled. A package can also be represented by a surface of a particular texture on which the bricks making up the package 53 can be placed.

A fourth brick 54 can represent a party intervening for example in a case of use of the system. A party can for example be a user of the system. A party can be characterized by a type, an identifier. The information making it possible to characterize and to identify the party can be represented on the fourth brick 54, or on a label attached to the fourth brick 54.

A fifth brick 55 can represent a state of the system for example in a case of use.

A sixth brick 56 can represent an activity of the system 6.

A seventh brick 57 can represent a dependency tie for example between two blocks. This tie can be a string, a cord or a copper wire for example.

An eighth brick 58 can represent a shared association between two blocks.

A ninth brick 59 can represent a part association between two blocks. Generally, the aggregations can be represented by wires, pipes with a rhombic end for example.

A tenth brick 500 can represent a note making it possible to include comments in the solid model.

For the example, FIGS. 6 to 9 are based on examples of conventional SysML models, so as to simply set forth the method of constructing models with the aid of solid bricks according to the invention.

FIG. 6 and those following illustrate examples of use of the method according to the invention to produce, and more particularly to design, a system 6. The system 6 used for the example is a vehicle 60. FIG. 6 represents a modeling diagram 696 for the automotive sector 61. For example, the modeling diagram 696 represents the environment 697 of an automotive vehicle 60. The environment 697 can be represented by a support of a defined texture and of a defined color. For example, in FIG. 6, the environment 697 is represented by a metallic color support. To design a system 6, it is paramount to identify all the elements external to the system 6 which are able to interact with the latter. In the case of an automotive system 60 or vehicle 60, the external elements can be occupants 62, 63, 64, luggage 66 and a physical external environment 65 comprising the road entity 69, atmosphere entity 68, other external entities 67 such as traffic lights, other vehicles. The automotive sector 61 can be represented in the form of a diagram of solid blocks such as is represented in FIG. 6 for example.

The automotive sector 61 is represented by a solid block. The automotive sector 61 is the block of highest level. The automotive sector block 61 can be composed of other blocks such as the vehicle 60, a driver 63, zero or several passengers 64, a physical environment 65, one or more items of luggage 66. The composition ties between the automotive sector 61 and the blocks 60, 63, 64, 65, 66 can be represented in the form of solid arrows 601, 631, 641, 651, 661. In the same manner, the physical environment block 65 can be composed of the road block 69, atmosphere block 68, external entity block 67. The composition ties between the physical environment block 65 can be represented respectively by solid arrows 691, 681, 671.

In the example represented in FIG. 6, the passengers 64, the driver 63 can derive from a block representing an occupant 62. The derivation ties can be represented by solid ties 621, 622.

Each block 60, 61, 62, 63, 64, 65, 66, 67, 68, 69 is identified by a label 600, 610, 620, 640, 650, 660, 670, 680, 690. Each label can comprise the name of the block, the number of object of the block being able to make up the system in the form of a cardinality such as for the attached label 640 attached to the passenger block 64 which defines the following cardinality: from zero to four. In the same manner, the cardinality associated with the driver 63 and noted on a driver label 630, is equal to one. The labels can also comprise types of data specific to the block to which they are attached:
a vehicle label 600, attached to the vehicle block can comprise speed information expressed in the form of a real number;
an atmosphere label 680, attached to the atmosphere block 68, can comprise temperature information in degrees Celsius, the humidity as a percentage;
a road label 690, attached to the road block 69, can comprise friction factor information expressed by a real number, an inclination expressed in radians.

FIG. 7 represents a block diagram 70 of a vehicle 60. The block diagram 70 makes it possible to represent sub-systems making up the vehicle. The vehicle 60 is represented on the block diagram 70 as a container which can be represented in the form of a support 87 of a particular color or texture for example.

The vehicle is composed of the following sub-systems:
suspensions 71;
brakes 72;
a chassis 86;
an interior 73;
a powertrain 74;
a starter 75;
a driving system 76;
an electrical system 77;
a tank 78;
an engine 79;
a differential 80;
a mechanical transmission 81;
a wheel set 82;
a processor and its controller 83.

Composition ties can be represented by sticks which link each sub-system to the vehicle 60. To represent the wheels of the vehicle 60, from the wheel set sub-system 82 leave two composition ties 820, 821, to represent each wheel set: a front set, a rear set. The engine 79 can be produced by two sub-systems: a four cylinder engine 85, or a six cylinder engine 84. The alternative between the two types of sub-systems 84, 85 is represented by a double composition tie 850, 840, the two composition ties 850, 840 being solidly fastened together.

FIG. 8 represents a construction as solid bricks according to the invention, of a conventional exemplary SysML diagram, exhibiting cases of use 20 of the vehicle system 60. The vehicle 60 is represented by a first support 21, the support 21 comprising cases of use of the vehicle 60. The cases of use of the vehicle 60 can be the following:
driving 23;
checking of the accessories 24, such as blinkers, lights, rear view mirrors, seats, a cigar lighter;
disembarking 25;
embarking 26.

Each case of use is linked to a party outside the vehicle 60. For example the driving case of use 23 is carried out solely by the driver 63. The checking of the accessories can be implemented by any occupant 62, namely the passengers 64 and the driver 63. In the same manner, the disembarking 25 and embarking 26 cases of use can be carried out by any occupant 62 of the vehicle 60, namely the driver 63 and a passenger 64. The occupants 62, passenger 64 and driver 63 are represented on a support 22 representing the exterior of the vehicle 60.

FIG. 9 represents an overall view of the modeling diagrams 696 of the automotive sector 61, of blocks 70 of the vehicle 60, of the cases of use 20. In FIG. 9 a first tie 90 makes it possible to link the various diagrams. The first tie 90 in fact links the vehicle object 60 present in each of the diagrams.

FIG. 10 represents an exemplary activity diagram 300 of a sub-system 302 of the vehicle system 60. FIG. 10 presents a simplified model 301 of an electrical system of the vehicle 60. The electrical system 301 comprises notably a processor 302. The activity diagram 300 represents an ABS system control algorithm, the acronym standing for Anti-lock Braking System, of the vehicle 60. The ABS system control algorithm can be implemented by the processor 302, by way of a software program running the algorithm. The input data of the algorithm are represented by a second tie 303 linked to the activity diagram by an input point IN and linked to the processor 302. The output data of the algorithm are represented by a third tie 304, linking outputs, notably two outputs OUT of the algorithm to the processor 302.

FIG. 11 represents a first example of an asynchronous sequence diagram 400 of a first case of use of the vehicle system 60 according to the invention. In FIG. 11, interactions between the driver 63, the vehicle 60 and an electrical service-station 401, are represented for the example. Thus, the driver dispatches a first start order 402 to the vehicle 60. The first order is received by a sub-system of the vehicle 60: a propulsion block 403 for example. The propulsion block estimating that the energy in a battery of the vehicle 60 is insufficient to start, it emits an energy request 404 to the electrical service-station 401. Thereafter, the driver can for example transmit a new order 405 to the propulsion block, requesting the turning off of the vehicle 60. First bars 406, 407, 408 represent respectively the driver 63, the vehicle 60, the electrical service-station 401, evolving over time.

FIG. 12 represents a second example of a synchronous sequence diagram in the first case of use of the system according to the invention. Notably, FIG. 12 represents a diagram of events occurring in the propulsion block 402. The synchronous sequence diagram 409 can represent a magnification of the synchronous sequence diagram 400 to represent in greater detail the processing operations carried out inside the propulsion block 402. The synchronous sequence diagram 409 implements the following parties, sub-system of the propulsion block 402: a starter 410, an engine controller 411, such as an injection pump for example, an engine battery 412. Second bars 413, 414, 415 represent respectively an evolution over time of the starter 410, engine controller 411, engine battery 412 sub-systems, respectively. When the propulsion block 402 receives a start order 403, the starter 410 transmits a start demand to the engine controller 411 on the one hand 416 and on the other hand 417 to the battery of the engine 412. If the battery of the engine 412 is operational, the controller of the engine 411 transmits the start order 418 to the battery of the engine 412. Optionally, if needed, the engine battery can issue an energy request 419 which will be routed to the electrical service station 401, such as represented in FIG. 12.

FIG. 13 represents an exemplary relationship between the asynchronous sequence diagram 400 and the asynchronous sequence diagram 409 represented respectively in FIGS. 11 and 12. The relationship between the two diagrams 400, 409 can be represented by a tie 420 between the propulsion block 402 represented on the asynchronous diagram 400 and the same propulsion block 402 represented on the synchronous diagram 402.

As and when the solid model is supplemented with various diagrams, a significant number of objects may become necessary. In order to reduce the production costs of a solid model according to the invention, the solid objects may be made of an abundant and cheap material, easy to cut such as expanded polyurethane foam boards. Expanded polyurethane furthermore exhibits the following advantages: it is dense, lightweight, cheap and convenient for cutting and for drilling. The connections between the objects can easily be produced by slender sticks, for example, with a pointed end able to penetrate the expanded polyurethane so as to physically tie the objects together.

By way of example, by following the method according to the invention, the whole set of solid brick models of FIGS. 6, 7, 8, 9, 10, 11, 12, 13 can be produced in a timescale of two hours, this being at least as fast as the construction of these same models with existing SysML modelers.

Advantageously, the solid model can obey a solid meta-model making it possible to define the bricks and the ties between the bricks. The meta-model can advantageously be suitable for the sector of the system produced, for example for the automotive sector. Thus, the solid model can be conveniently created, understood, validated, and modified by experts in the sector of the system who are not necessarily trained in the use of another modeling language, such as the SysML, for example. Advantageously, the use of such a meta-model makes it possible to improve the ease of understanding of the system by designers. Thus the quality of the system and productivity are improved by the design method according to the invention.

Moreover, a solid design model according to the invention advantageously allows the understanding of the modeled system: indeed, naturally, the human brain more easily assimilates and analyzes tangible and palpable objects. It thus suffices to scan the solid model with the eyes to get a global picture of it. Finally, it is simple to change viewpoint by moving around the model for example.

In addition to the advantages of understanding the system by virtue of the solid model according to the invention, a solid model such as this can be constructed very rapidly. The time saving with respect to the production of the same model with design software makes it possible to rapidly represent concepts of construction of the system so as to render them understandable to all the designers of the system. Moreover, there is no space limit as regards the dimensions of the solid model, the latter being able to be constructed in a hangar for example or in a meeting hall depending on the level of detail desired.

Another advantage of the use of a solid model is that it may optionally serve as support for the porting of the solid model from a first design software using a first meta-model to a second design software using a second meta-model.

FIGS. 14 and 15 represent the data structures 150 maintained in the computerized device, according to an embodiment of the invention.

In this embodiment, the data structures of the computerized device comprise a first data structure, for example a database, designated hereinafter “BD-BS”, associated with the solid bricks. The data structure BD-BS can be read dynamically as and when the solid bricks are constructed. It is initialized with the information relating to the system of solid bricks. The structure BD-BS advantageously comprises an entry for each solid brick of the chosen system of solid bricks. The data structure BD-BS associates with each solid brick available for use in the solid model a set of fields representative of the properties of the bricks (e.g. “size”, “shape”, “materials”, “color”, “connection points”, “photos”, “constraints” fields, etc.). In the embodiments of the invention, where each brick of the solid model is associated with a single identifier (for example carried by an RFID label or a barcode), this identifier can be used as primary key of the entries of the data structure BD-BS.

The data structures 150 can furthermore comprise a second data structure, designated hereinafter “BD-DA”, associated with the architectural description of the system, including all the views, the models associated with each view and the correspondences between the models. This structure BD-DA can in particular take the form of a database. The data structure BD-DA advantageously contains the elements of the models which comply with the SysML standard.

The data structures 150 can also comprise a third data structure, designated hereinafter “BD-MS”, for example in the form of a database. This structure BD-MS stores the data relating to the solid models which supplement the standard architectural description whose information is maintained in the structure BD-DA. BD-MS can therefore be used for the reconstruction of the solid model in the case, for example, where the data structures BD-MS and BD-DA are dispatched to another team.

When a given solid brick is used in a solid model, the entry which is associated with this brick in the base BD-BS is copied into the structure BD-MS. The structure BD-MS furthermore contains fields representative of the positioning of the solid bricks in the solid model as well as other fields describing the characteristics of each solid connection (e.g. the properties of the attachment between two solid bricks).

Advantageously, the identifier associated with a solid brick is used as primary key in the three data structures, thereby making it possible to synchronize the information of the three structures.

The modeling of a system can thus be entirely represented in the two data structures BD-DA and BD-MS, the first data structure BD-DA containing the standard SysML models while the second data structure contains the physical characteristics of the models that were constructed with solid bricks (FIG. 15). Furthermore, the evolution of a model can be dynamically reflected in these data structures, by means of the design method according to the invention. Such data structures thus make it possible to pass from the physical solid model to the SysML model or vice versa, in a transparent manner, and thus to benefit from the combined advantages of the physical modeling and of the computerized modeling.

In one embodiment of the invention, provision is made to associate a single identifier with any element of the architectural description, be it a component or a tie between 2 components. The single identifier is advantageously used to maintain a correspondence between the information maintained in the data structures 150 and the physical solid model. The identifier can be chosen in the form of a series of bytes having a single value for each element. The identifier can be associated with the solid bricks of the physical model by means of a suitable support such as a label stuck on the solid brick which contains the value of this identifier, a barcode (in 1D or 2D) stuck on the solid brick, an RFID tag integrated into the solid brick, or any other support making it possible to capture the information relating to the identifier by means of a suitable electronic or computerized device.

The subsequent description will be given with reference to a support of barcode type affixed to each solid brick and containing the identifier of the brick, by way of nonlimiting example.

The solid bricks which can be used for the construction of the solid model can be of various types, for example in the form of hardware blocks having a chosen shape (e.g. cubes, spheres, cones, tetrahedrons, wheels or any geometric shape in 3 dimensions).

The solid links can have any physical form representing a connection between two bricks (for example, rigid rods, wires which change shape, arrows, etc.).

The solid containers which represent the notion of packages or namespaces can have any structure suitable for containing or supporting a set of bricks (e.g. boxes, trays, etc.).

The solid diagrams have a different semantics from the solid containers in that they correspond to a partial solid representation of the system architecture. They can be constructed with the aid of any suitable physical element such as jars or trays. The representation chosen may be such that it makes it possible to distinguish the diagrams of structures and those of behaviors (activities, case of use, sequences, communications, automatons, etc.).

The subsequent description will be given with reference to an embodiment in which the solid links are configured to link two solid blocks together, by way of nonlimiting example. According to this embodiment, there thus exist connection points predefined on each solid brick making it possible to connect a solid link with a solid block. In the subsequent description, two categories of solid bricks will furthermore be distinguished for illustrative purposes: solid blocks and solid links.

In the solid model, each solid block has a given position in physical space, for example a position represented by the coordinates (x,y,z) where x, y, z are integers. Of course, the person skilled in the art will understand that various arrangements of the solid blocks in space are possible (they may be for example superimposed with the aid of trellises).

FIG. 16 represents the architecture of the design device 160 according to an embodiment of the invention. It comprises at least one server 1600 which can be equipped with a monitor hosting the data structures 150 (BD-BS, BD-MS and BD-DA), a set of fixed or mobile information capture devices 1602 (also called reading devices in the present description) configured to read the identifier of the solid elements of the model, such as for example one or more tablets furnished with a barcode reader and provided to the participants in the modeling. The information capture devices 1602 can furthermore be equipped with a position detection module configured to detect the position of a new element of the solid model. The information capture devices 1602 are connected to the server 1600 and are arranged in a physical zone dedicated to the construction of the solid model 62 and also called the construction zone, so as to be in the zone of range of the supports chosen on the bricks. In the construction zone, the participants (technical experts, architects, etc.) employ a set of solid elements (in the form of a kit) containing a plurality of solid blocks and of solid links (1608) associated with the data structure BD-BS which was installed as a preliminary on the server 1600. These elements will be able to be added to the solid model (1606) in tandem with the design in order to upgrade it, while the server will capture this information quasi-dynamically so as to update the SysML model.

FIG. 17 is a flowchart representing the various steps implemented by the design method, in response to the addition of solid blocks to the solid model, according to an embodiment of the invention.

In step 1700, in response to the addition of a solid block to the solid model at a given location of the construction zone, the capture devices 1602 (or reading devices) determine the identifier associated with the solid block, for example by reading the barcode associated with this block when the capture devices are of barcode reader type connected to an electronic tablet. As a variant, the identifier can be captured dynamically in the embodiments where the capture devices are suitable for detecting the supports situated in a zone of range (for example, RFID readers disposed so as to cover the construction zone).

In step 1702, the capture devices 1602 transmit the information to the server 1600.

In step 1704, the server reads the identifier and creates an entry associated with this identifier in the two data structures BD-DA and BD-MS.

In step 1706, it selects the entry corresponding to the identifier in the data structure BD-BS, and copies the part of the fields which are associated with this entry which represent solid block properties, such as physical properties (for example size, shape, photo, alloy, etc.), in the entry of the data structure BD-MS which has as primary key the identifier read (entry created in step 1704). In step 1707, the server copies the other part of the fields of the entry BD-BS which correspond to SysML properties into the entry of the data structure BD-DA which has as primary key the identifier received (entry created in step 1704). The identifier of the solid block thus makes it possible to effect the association between the fields tied to this block in the three data structures of the data structures 150.

In step 1702, the capture devices 1602 can also identify the position (x,y,z) of the solid block when the latter is positioned in the solid model and transmit it to the server 1600, in the embodiments where the information capture devices comprise a position detection module. The server will then store these coordinates in the entry corresponding to the identifier of the block in the data structure BD-MS in step 1706.

As a variant, for example when the information capture devices 1602 take the form of at least one tablet furnished with a barcode reader, the server can generate the display of a checking tool having a graphical interface allowing interactions between the user or users and the server in a step 1708. The checking tool can be displayed on an item of computerized equipment distinct from the capture devices (for example central monitor) and/or on a display device associated with the capture devices, for example on the screen of the tablet of the user that read the identifier when the capture devices are of tablet type. Display on a central monitor allows the other users possibly present in the construction zone, which may be for example a table, to follow the evolution of the modeling. The user can use this checking tool to declare the properties of the solid block and/or the SysML properties associated with this solid block if they were not stored initially in the data structure BD-DA. In response to such data entries, the server updates this information in the data structure BD-DA in step 1710.

The user can then position the solid block in the solid model and input the position coordinates (x,y,z) of this block on the graphical interface of the checking tool. These coordinates are then transmitted to the server in step 1712 which stores them in the data structure BD-MS.

Steps 1700 to 1712 are repeated for each solid block positioned in the model.

When a user introduces a solid link between two solid blocks previously positioned into the solid model, in the physical construction zone, the information capture devices 1602 are configured to read the barcode of the solid link so as to extract the identifier of the link in step 1800. The identifier of the link is dispatched to the server which by access to the base BD-BS determines that it entails a connection element in step 1802. It then dispatches an instruction to read the identifiers of the solid blocks connected by the solid link. The capture devices 1602 then read the identifiers associated with the blocks connected by the solid link in step 1804, and transmit to the server in step 1806. In step 1808, the server creates an entry associated with the link in the data structures BD-DA and BD-MS having as primary key the identifier of the link. In step 1810, the server copies the fields of the entry corresponding to the identifier of the link in the data structure BD-BS to the structure BD-MS when they relate to physical properties of the link and to the data structure BD-DA when they relate to SysML properties (step 1812). The identifier of the link makes it possible to associate the fields tied to the link in the 3 data structures. The server furthermore updates the information regarding connections between the solid blocks in the data structure BD-DA and the data structure BD-MS in response to the reading of the 2 identifiers associated with the blocks connected by the current link in step 1814.

The user can introduce the properties of the connection points into the checking tool. They will then be transmitted to the server which will store the properties in the data structure BD-MS.

Steps 1800 to 1814 are repeated for each solid link positioned in the physical model.

As a supplement, the design device according to the invention allows any user in the construction zone to verify the properties of a solid element via the graphical interface of the checking tool by scanning the identification support for the solid element (for example barcodes of this brick).

As a supplement, auxiliary labels may be affixed to the solid bricks to facilitate the understanding of the solid model. The information carried by these labels is then transmitted to the server via the checking tool or by any suitable means so that the server 1600 stores this information in the data structure BD-MS.

Thus, in one and the same architectural description, several solid models of one and the same system can be constructed according to the invention with different users so as to take various avenues into account. The design device according to the invention makes it possible to maintain a correspondence almost in real time between the physical model and the SysML data, and thus to exploit at one and the same time the real modeling environment and the computerized modeling environment to culminate in an optimized and complete model.

The design device according to the invention allows users (designers, architects, etc.) to specify modeling inputs in an unrestricted real space which offers a clear view of the model in the course of construction, while utilizing the calculation resources of the computerized modeling system. The synchronization between the two work environments is effected in a quasi-transparent manner, and requires a minimum of operations on the part of the users.

By directly manipulating the solid model whose information is captured by the server in quasi-real time, the users can collaborate in a more effective manner while utilizing the resources of the computerized modeling tools. The SysML model is captured in parallel and evolves quasi-dynamically with the solid model. However, the data relating to the SysML modeling and to the physical modeling are maintained in distinct data structures capable of communicating with one another by virtue of the identifiers of solid blocks. The architect can at any moment add (non-physical) SysML diagrams to afford support for the solid model, without this affecting the base DB-MS tied to the solid model. The result of the dematerialization of the solid model (capture of the physical model by the server) is maintained in the data structure DB-MS. This data structure can be transmitted on demand to any geographical location for the reconstruction of the solid model (materialization).

1. A method of designing a system, comprising: as a preliminary the construction of a solid model of the system, said solid model being constructed according to a solid meta-model, said solid model using solid bricks (71, 72, 73, 74, 75, 76, 77) representing sub-systems of the system, solid ties representing relationships between the sub-systems of the system, the solid bricks and the solid ties being physical objects associated with a respective identifier, and further comprising, in response to a modification of the solid model, a step of converting the solid model into a design model suitable for being interpreted by a computer, on the basis of the identifiers associated with each brick and with each solid tie, said conversion step comprising the conversion of the solid model into a set of data representative of the solid model and maintained in a first data structure relating to the solid model, said data structure being associated with a second data structure relating to the design model.

2. The method as claimed in claim 1, further comprising the conversion of the design model into assembly instructions for modifying the solid model in response to a modification of the design model.

3. The method as claimed in claim 1, wherein the design model is a SysML model.

4. The method of designing of a system as claimed in claim 1, wherein the solid model comprises static diagrams and dynamic diagrams, the static diagrams defining the ties between the solid bricks, the dynamic diagrams defining successions of processing operations, of exchanges of messages between the sub-systems of the system.

5. The method of designing a system as claimed in claim 1, wherein the solid meta-model defines a grammar for the solid model, a context of use of the system, a mode of representation of the solid bricks and ties according to their type.

6. The method of designing a system as claimed in claim 1, wherein each solid brick and each solid tie comprises an identification label associated with its identifier.

7. The design method as claimed in claim 1, wherein the identifiers of the solid bricks and ties are read by means of a digital device for reading and recognition of the solid model.

8. The design method as claimed in claim 7, wherein the solid model once read is transcribed into a file comprising data necessary for the description of the solid model and for the interpretation of the data for describing the solid model by a computer.

9. The method of designing a system as claimed in one of the preceding claims claim 1, wherein the data structure associated with the solid model stores the physical characteristics of each solid brick of the solid model.

10. The method of designing a system as claimed in claim 1, further comprising a step of converting the data maintained in the data structure relating to the solid model into assembly instructions for constructing the corresponding solid model.

11. The method of designing a system as claimed in claim 10, wherein the step of converting the data maintained in the data structure relating to the solid model into assembly instructions comprises a step of transcribing the data maintained in the data structure relating to the solid model into a description file comprising data of the description of the solid model.

12. The method of designing a system as claimed in claim 1, further comprising a step of identifying differences between the solid model and the data maintained in the data structure.

13. The method of designing a system as claimed in claim 1, wherein the solid meta-model comprises representation concepts present in the SysML standard, the acronym standing for the expression Systems Modeling Language.

14. The method of designing a system as claimed in claim 1, wherein the solid meta-model comprises representation concepts present in the UML standard, the acronym standing for the expression Unified Modeling Language.

15. The method as claimed in claim 14, further comprising a step of generating software code used by a software sub-system of the system.

16. A device for designing a system, further comprising:
a computerized device,
a construction zone for the construction of a solid model according to a solid meta-model, said solid model using solid bricks representing sub-systems of the system, solid ties representing relationships between the sub-systems of the system, the solid bricks and the solid ties being physical objects associated with a respective identifier, and
at least one device for reading the solid model, said devices converting information describing the solid model into digital data,
the device being able, in response to a modification of the solid model, to convert the solid model into a design model suitable for being interpreted by the computerized device, on the basis of the identifiers associated with each brick and with each solid tie that are read by the reading devices, said conversion comprising the conversion of the solid model into a set of data representative of the solid model and maintained in a first data structure relating to the solid model, said first data structure being associated with a second data structure relating to the design model.

17. The device for solid design of a system as claimed in claim 16, wherein the identifiers are inscribed on respective labels with the aid of digital styluses each comprising a system for reading hand-written data, the devices for reading the solid model consisting of the hand-written data reader systems of the digital styluses.

18. The device for solid design of a system as claimed in claim 16, wherein the identifiers are carried by labels of RFID tag type, the acronym standing for the expression Radio Frequency Identification, and in that the devices for reading the solid model are RFID reader devices.

19. The device as claimed in claim 18, wherein the devices for reading the solid model comprise at least three RFID readers which determine, according to a triangulation method, a disposition of the solid bricks and ties in a space of representation of the solid model.

20. The device as claimed in claim 16, wherein the identifiers are carried by labels of barcode type, and in that the reading devices furthermore comprise barcode reader devices.

21. The device as claimed in claim 16, wherein the devices for reading the solid model are designed to convert the read data into data suitable for being transmitted to a computer and for being interpreted by a computer.

22. The device as claimed in claim 16, wherein the device comprises a robot able to construct the solid model according to instructions generated by the computer comprising the description of the solid model.
